(19) United States
(12) Patent Application Publication
(10) Pub. No.: US 2011/0217571 A1
(43) Pub. Date: Sep. 8, 2011

(54) BATTERY PACK AND METHOD OF MANUFACTURING SAME

(75) Inventors: Jong-Pil Kim, Yongin-si (KR); Woon-Seong Baek, Yongin-si (KR); Dae-Geun Kim, Yongin-si (KR)

(73) Assignee: Samsung SDI Co., Ltd., Yongin-si (KR)

(21) Appl. No.: 12/975,237

(22) Filed: Dec. 21, 2010

Related U.S. Application Data
(60) Provisional application No. 61/310,193, filed on Mar. 3, 2010.

(51) Int. Cl. H01M 2/00; H01M 10/04

(52) U.S. Cl. 429/7; 29/623.1

(57) ABSTRACT

A battery pack comprising a bare cell and a protection circuit module positioned on top of the cap plate of the bare cell and a cover. Threaded connectors are used to connect the cover to the bare cell. The threaded connectors are chemically polished to enhance the engagement between the connectors and the cap plate.

This application claims the benefit of U.S. Provisional Patent Application No. 61/310,193, filed Mar. 3, 2010 entitled BATTERY PACK AND METHOD OF MANUFACTURING SAME which is hereby incorporated in its entirety by reference herein.

### DETAILED DESCRIPTION OF THE INVENTION

1. Technical Field

One or more embodiments of the present invention relate to a battery pack and a method of manufacturing the same, and more particularly, to a battery pack including a tapping screw and a method of manufacturing the battery pack.

2. Related Art

Recently, compact and light portable electric/electronic devices, such as cellular phones, notebook computers, camcorders, etc., are being actively developed and produced. Accordingly, portable electric/electronic devices include battery packs so that they can be operated even in places where additional power sources are not available. Battery packs often employ economical secondary batteries capable of charging and discharging. Representative secondary batteries include a nickel (Ni)-cadmium (Cd) battery, a Ni-MH battery, a lithium (Li) battery, a Li-ion secondary battery, etc. The operating voltage of the lithium ion secondary battery is about three times higher than that of the Ni—Cd battery or the Ni-MH battery, which are usually used as a power source of portable electronic devices. Also, the Li-ion secondary battery is widely used in view of high energy density per unit weight. Secondary batteries generally use lithium-based oxides as positive electrode active materials and carbon-based materials as negative electrode active materials. In general, a secondary battery may be a liquid electrolyte battery or a polymer electrolyte battery according to the type of electrolyte in the secondary battery. In this instance, a Li battery using a liquid electrolyte is referred to as a Li-ion battery, and a Li battery using a polymer electrolyte is referred to as a lithium polymer battery.

A secondary battery includes a bare cell that is formed by sealing a can accommodating an electrode assembly and an electrolyte, and a protection circuit substrate electrically connected to the bare cell. The bare cell charges/discharges electricity via a chemical reaction. The protection circuit substrate controls charging/discharging of the bare cell and prevents overcharging/overdischarging of the bare cell to protect the bare cell.

When the bare cell and the protection circuit are connected to form the secondary battery, electrical resistance therebetween should be reduced in order to improve charging/discharging efficiency. More specifically, if the electrical resistance between the bare cell and the protection circuit module is great, the charging/discharging efficiency of the bare cell is reduced.

Secondary batteries may go through a reliability test for determining whether the secondary battery is stable enough to withstand impacts. These impacts include those caused when the secondary battery is mounted in an electronic product by integrally connecting the bare cell and the protection circuit substrate. If there is an external impact, the electrical resistance between the bare cell and the protection circuit substrate is increased. The electrical resistance increases as contact resistance increases where the bare cell and the protection circuit substrate are connected.

### SUMMARY OF THE INVENTION

The aforementioned needs are satisfied by the present invention which in one embodiment comprises a battery pack comprising a bare cell having an electrode assembly and a cap plate, a protection circuit module positioned on top of the cap plate and a cover that is positioned over the protection circuit module. In this embodiment the battery back also includes at least one threaded connector that engages with the cover and the protection circuit module and is secured into the cap plate so as to secure the cover and the protection circuit module to the cap plate. In this embodiment, the threads of the at least one connector are polished and the polished threads engage with the cap plate to secure the at least one threaded connector to the cap plate.

In one embodiment, the connectors are polished by chemical polishing.

In one embodiment, the battery pack also includes at least one tap that supports the protection circuit module to the bare cell, wherein the at least one tap includes an opening that receives the threaded shaft of the at least one threaded connector.

In one embodiment, the threaded connector can comprise one or more screws.

In one embodiment, the battery pack also includes a cap that is positioned within the opening of the cover so that the cap is interposed between the exterior of the opening and the at least one threaded connector.

In another embodiment, the invention comprises a method of making a battery pack that includes providing at least one threaded connector that is dimensioned to be used to secure a cover and a protection circuit module to a bare cell of a battery pack. The method further comprises polishing the at least one threaded connector to polish the threads of the at least one threaded connector so as to control the size of the threads of the at least one threaded connector.

In one embodiment, the step of polishing the at least one threaded connector comprises chemically polishing the threaded connector.

These and other objects and advantages of the battery pack will become more apparent from the following description taken in conjunction with the accompanying drawings.

### BRIEF DESCRIPTION OF THE DRAWINGS

FIG. 1A is an exploded perspective view illustrating a battery pack, according to an embodiment of the present invention;

FIG. 1B is a perspective view illustrating a coupled state of the battery pack of FIG. 1A;

FIG. 1C is a cross-sectional view taken along a line Ic-Ic′ of FIG. 1B;

FIG. 2 is a schematic exploded perspective view illustrating sizes of portions of a battery pack, according to an embodiment of the present invention;

FIG. 3A is an enlarged cross-sectional view of a part 111a of FIG. 1C;

FIG. 3B is a cross-sectional view illustrating a state where a random free fall (RFF) test has been performed on the embodiment of FIG. 3A;

FIG. 4 is a schematic cross-sectional view illustrating a tapping screw, according to an embodiment of the present invention;

FIG. 5 is a flowchart of a method of manufacturing a tapping screw, according to an embodiment of the present invention; and

FIG. 6 is a flowchart of a chemical polishing process.

### DESCRIPTION OF EMBODIMENT

Reference will now be made in detail to embodiments, examples of which are illustrated in the accompanying drawings.

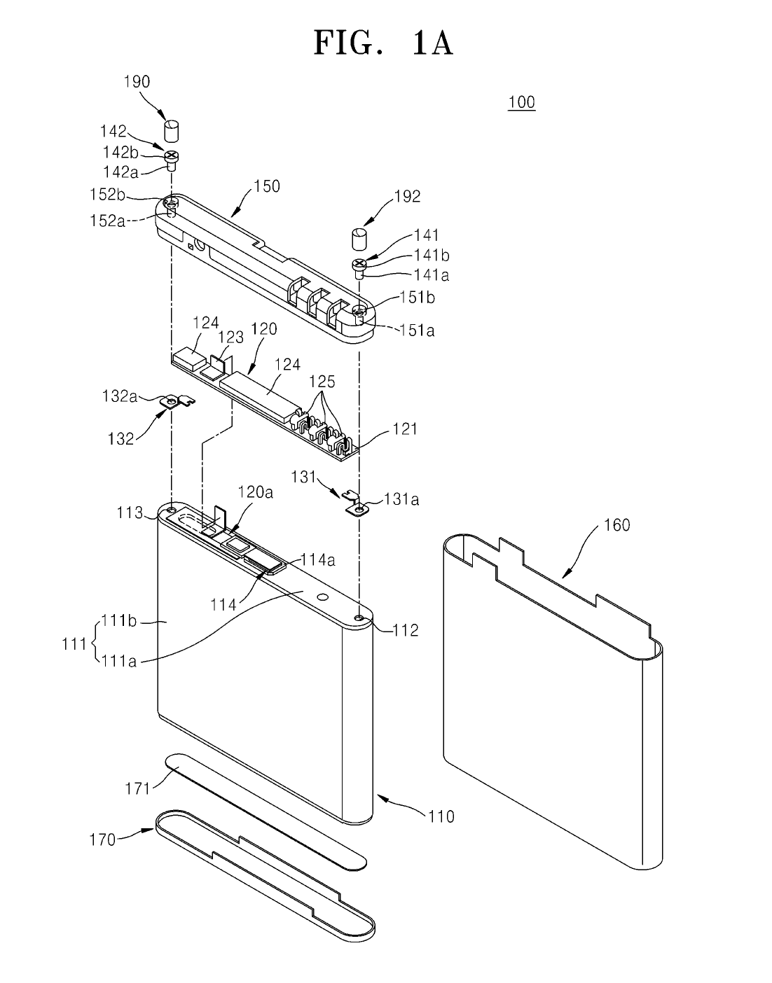

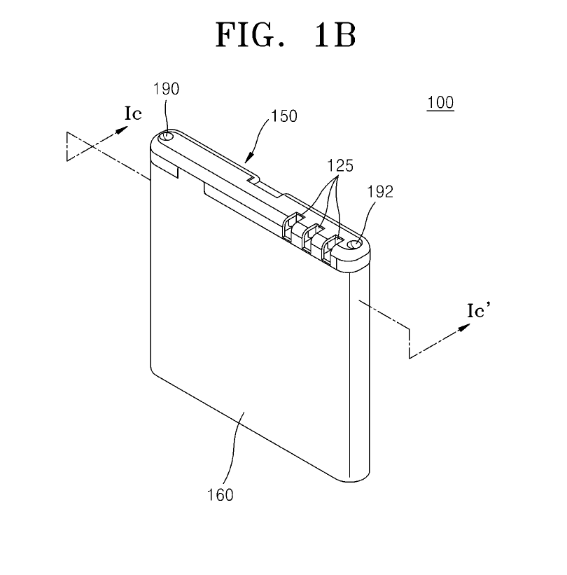

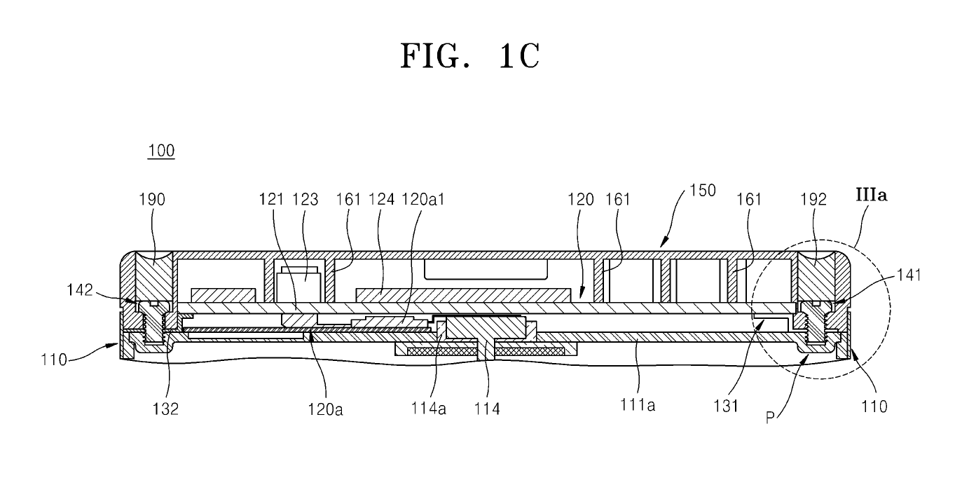

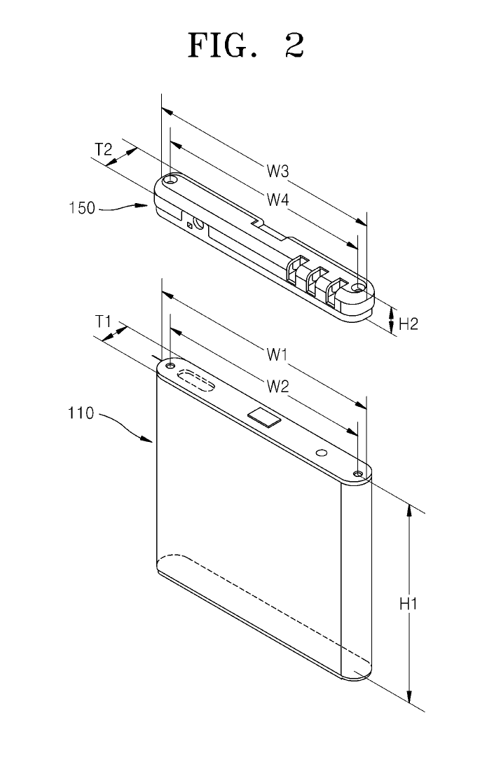

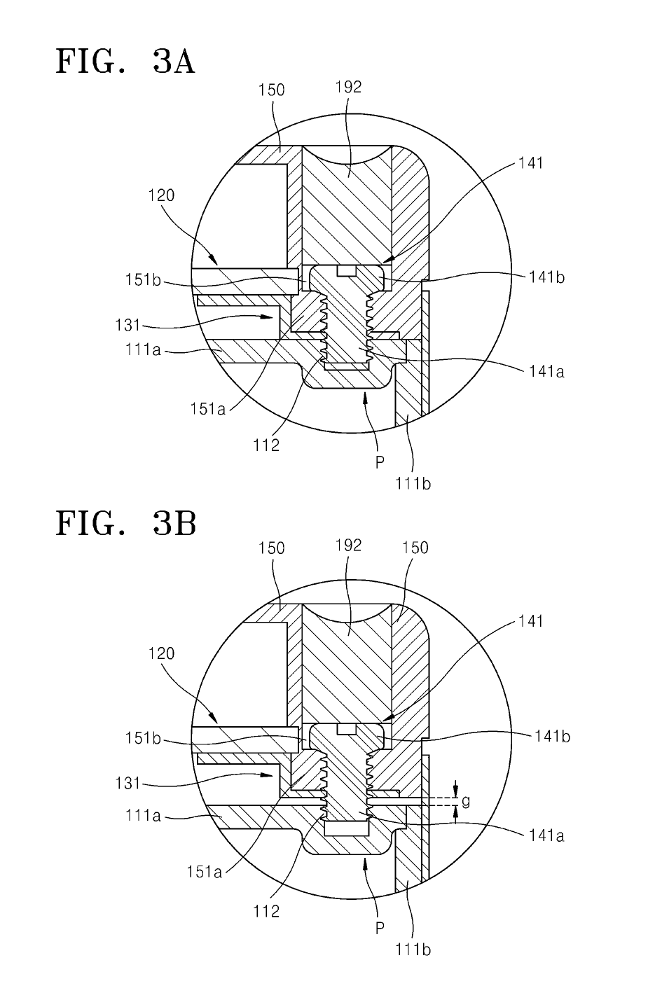

According to an embodiment of the present invention, a battery pack 100 relates to tapping screws 141 and 142 for coupling a bare cell 110 and a case 150, and to a method of manufacturing the tapping screws 141 and 142. Hereinafter, the battery pack 100 will be described with reference to FIGS. 1A through 1C and 2, and the tapping screws 141 and 142 and the method of manufacturing the same will be described with reference to FIGS. 3 through 6.

FIG. 1A is an exploded perspective view illustrating a battery pack, according to an embodiment of the present invention. FIG. 1B is a perspective view illustrating a coupled state of the battery pack of FIG. 1A. FIG. 1C is a cross-sectional view taken along a line Ic-Ic′ of the battery pack of FIG. 1B. As illustrated in FIGS. 1A through 1D, the battery pack 100 includes a bare cell 110, a protection circuit substrate 120, a cover case 150, and tapping screws 141 and 142.

The bare cell 110 includes an electrode assembly (not shown) and a sealing assembly 111 accommodating the electrode assembly. The electrode assembly may be formed by winding a positive electrode plate (not shown), a negative electrode plate (not shown), and a separator (not shown) in a known manner.

The sealing assembly 111 may include a cap plate 111a and a metal type can 111b and may be formed of a conductive material, for example, aluminum. The metal type can 111b has an open end, and the cap plate 111a covers the open end of the metal type can 111b. An electrode terminal 114 that is insulated by an insulator 114a may be formed in either the metal type can 111b or the cap plate 111a.

Referring to FIGS. 1A and 1C, the electrode terminal 114 insulated by the insulator 114a is inserted into the cap plate 111a. The positive electrode plate of the bare cell 110 may be electrically connected to the sealing assembly 111, and the negative electrode plate of the bare cell 110 may be electrically connected to the electrode terminal 114. The electrode terminal 114, which is connected to the negative electrode plate of the bare cell 110, and the sealing assembly 111, which is connected to the positive electrode plate of the bare cell 110, may have different polarities.

In the current embodiment, the electrode terminal 114 is electrically connected to the negative electrode plate of the electrode assembly of the bare cell 110 to be a negative electrode P−, and the sealing assembly 111 is electrically connected to the positive electrode plate of the electrode assembly of the bare cell 110 to be a positive electrode P+, but the present invention is not limited thereto. In other words, the bare cell 110 may be a rectangular battery in which the electrode assembly is sealed by the sealing assembly 111 formed of a metal material, and in which any one of the positive electrode plate and the negative electrode plate of the electrode assembly is electrically connected to the sealing assembly 111, and the other plate is connected to the electrode terminal 114.

In this embodiment, the bare cell 110 may be a secondary battery. For example, the bare cell 110 may be an ion battery or a lithium polymer battery. However, the present invention is not limited thereto. Thus, the bare cell 110 may be a secondary battery such as a nickel (Ni)-cadmium (Cd) battery, a Ni-metal hydride (MH) battery, or the like.

In this embodiment, one surface of the cap plate 111a of the bare cell 110 may include at least one selected from the group consisting of screw receiving openings 112 and 113. Referring to FIG. 1A or 1C, the cap plate 111a includes the first screw receiving opening 112 and the second screw receiving opening 113. The first screw receiving opening 112 may be coupled with the first tapping screw 141, and the second screw receiving opening 113 may be coupled with the second tapping screw 142. Also, a screw thread may be formed in each of inner circumferential surfaces of the first and second screw receiving openings 112 and 113 in order for the first and second tapping screws 141 and 142 to be coupled therewith. The cap plate 111a may form a protruding part P corresponding to the screw receiving openings 112 and 113.

The protection circuit substrate 120 may include an insulating substrate 121, a printed circuit pattern (not shown), a conductive pad 123, a protection circuit unit 124, a charging/discharging terminal 125, and first and second taps 131 and 132. The conductive pad 123, the protection circuit unit 124, and the charging/discharging terminal 125 may be soldered to the printed circuit pattern formed on the insulating substrate 121. The protection circuit substrate 120 may be electrically connected to the bare cell 110. That is, a negative electrode of the protection circuit substrate 120 may be electrically connected to the electrode terminal 114, which is the negative electrode P− of the bare cell 110, by a lead tap 120a, and a positive electrode of the protection circuit substrate 120 may be electrically connected to the sealing assembly 110, which is the positive electrode P+ of the bare cell 110, by the first tap 131. A positive temperature coefficient (PTC) device 120a1 is electrically connected between the negative electrode of the protection circuit substrate 120 and the electrode terminal 114 and may block the electrical connection between the negative electrode of the protection circuit substrate 120 and the electrode terminal 114 when the temperature thereof is excessively high or a current excessively flows therethrough. The protection circuit unit 124 may selectively comprise a passive device such as a resistor, a capacitor, or the like, an active device such as a field-effect transistor, a safety device such as the PTC device 120a1, and integrated circuits. The protection circuit unit 124 charges or discharges the bare cell 110 when the bare cell 110 is to be charged/discharged, and blocks a charging/discharging path in the bare cell 110 when the bare cell 110 is overheated or is in an overcurrent state, thereby protecting the bare cell 110 from lifetime degradation, overheating, exploding, and the like.

The first and second taps 131 and 132 are respectively formed on different ends of the protection circuit substrate 120 to electrically connect the protection circuit substrate 120 and the bare cell 110. First and second coupling holes 131a and 132a may be formed in the first and second taps 131 and 132 corresponding to the screw receiving openings 112 and 113, respectively. Referring to FIG. 1C, the first tap 131 and the second tap 132 are connected to the cap plate 111a of the bare cell 110. The first and second coupling holes 131a and 132a respectively corresponding to the first and second screw receiving openings 112 and 113 of the cap plate 111a are formed in the first tap 131 and the second tap 132. The first tap 131 and the second tap 132 support the protection circuit substrate 120 so that the protection circuit substrate 120 is mounted on a surface of the bare cell 110, and electrically connect the positive electrode of the protection circuit module 120 and the positive electrode of the bare cell 110.

Both the first and second taps 131 and 132 may be formed of Ni or an alloy containing Ni, and may be soldered to the protection circuit substrate 120. In this case, in FIG. 1A, the protection circuit substrate 120 is connected to two taps, that is, the first and second taps 131 and 132, but the number of taps is not limited to two. For example, the protection circuit substrate 120 may include only the first tap 131.

The first and second tapping screws 141 and 142 include body parts 141a and 142a and head parts 141b and 142b. The body parts 141a and 142a of the first and second tapping screws 141 and 142 include a screw thread that is screw-coupled to the screw receiving openings 112 and 113 of the bare cell 110. The head parts 141b and 142b of the first and second tapping screws 141 and 142 are formed in an upper part of the body parts 141a and 142a, and have a diameter greater than those of the body parts 141a and 142a. In FIG. 1A, grooves marked with + are formed in the head parts 141b and 142b of the first and second tapping screws 141 and 142 to facilitate rotation. The shape of the grooves is not limited thereto. In the present invention, one of ordinary skill in the art may embody the groove having various shapes. In addition to the mark +, the grooves may be marked with ‘− or *. A screw driver is inserted into the grooves so that the first and second tapping screws 141 and 142 may be screw-coupled to the bare cell 110. The first and second tapping screws 141 and 142 are coupled to the first and second screw receiving openings 112 and 113b formed on different sides of the bare cell 110, so that the protection circuit substrate 120 may not be twisted and so that the coupling between the first and second taps 131 and 132 and the protection circuit substrate 120 by soldering is enhanced, thereby preventing an increase in contact resistance. Also, the first and second tapping screws 141 and 142 include a conductive material, so that the protection circuit substrate 120 and the bare cell 110 may be electrically connected to each other via the first and second taps 131 and 132.

A screw groove may be formed in an inner circumferential surface of the screw receiving opening 112 to be coupled with the first tapping screw 141. Alternatively, the screw groove is not formed, and the inner circumferential surface is formed to be smaller than an outside diameter of the first tapping screw 141, so that the screw thread of the first tapping screw 141 is coupled to the inner circumferential surface of the screw receiving opening 112 by cutting an outer surface of the screw groove. For example, the inner diameter of the screw receiving opening 112 of the cap plate 111a may be greater than an inner diameter of the body part 141a and less than an outside diameter of the body part 141a. Therefore, when the screw receiving opening 112 is coupled to the first tapping screw 141, the inner circumferential surface of the screw receiving opening 112 is deformed to be tightly adhered to the body part 141a of the first tapping screw 141. The cap plate 111a may include a light alloy, such as aluminum, so as to be easily deformed by the screw thread 141a1 of the first tapping screw 141.

The cover case 150 includes at least one selected from the group consisting of first and second holes 151a and 152a. Mounting grooves 151b and 152b are formed outside of the first and second holes 151a and 152a. For example, the mounting grooves 151b and 152b are formed to have inner diameters greater than those of the first and second holes 151a and 152a so as to support head parts 141b and 142b of the first and second tapping screws 141 and 142. Hereinafter, the mounting grooves 151b and 152b will be referred to as a first mounting groove 151b and a second mounting groove 152b, respectively. The first tapping screw 141 may be coupled to the first screw receiving groove 112 formed in the bare cell 110 after passing through the first hole 151a formed in the cover case 150 and the first coupling hole 131a formed in the first tap 131. The head part 141b of the first tapping screw 141 may be tightly adhered to the first mounting groove 151b of the cover case 150. The second tapping screw 142 may be coupled in a similar manner. Therefore, the first tapping screw 141 and the second tapping screw 142 couple the cover case 150 to the bare cell 110. The cover case 150 is, in one embodiment, a plastic case made by molding a resin material such as polycarbonate, and protects the protection circuit substrate 120 from an external impact and protects against a short circuit in the protection circuit substrate 120.

Referring to FIG. 1C, a rib 161 is formed inside the cover case 150, and the rib 161 supports an upper surface of the protection circuit substrate 120 to tightly adhere the protection circuit substrate 120 to the bare cell 110, which inhibits the protection circuit substrate 120 from moving, and the contact resistance between the first and second taps 131 and 132 soldered to the protection circuit substrate 120 and the bare cell 110 from increasing. When the cover case 150 is coupled with the first and second tapping screws 141 and 142, the first and second taps 131 and 132 are more tightly adhered to the bare cell 110 to reduce the possibility of an increase in the contact resistance between the first and second taps 131 and 132 and the bare cell 110.

In this case, the contact resistance between the first and second taps 131 and 132 and the bare cell 110 may be measured through a random free fall (RFF) test. The RFF test is performed by dropping six battery packs 100 at the same time from a height of 1 meter two hundred times to measure contact resistance. In this case, the structure of the battery pack 100 may be controlled so that variation of the contact resistance obtained by the RFF test is less than a predetermined value. The variation of the contact resistance may be controlled to be less than 14 ma Table 1 shows results of the RFF test performed on the battery pack 100.

TABLE 1

| | Initial | | | | | |
|---|---|---|---|---|---|---|
| | Value | 50 times | 100 times | 150 times | 200 times | |
| No. | (mΩ) | (mΩ) | (mΩ) | (mΩ) | (mΩ) | Result |
| 1 | 134.5 | 137.4 | 141.5 | 146.5 | 144.3 | good |
| 2 | 131.5 | 135.7 | 138.7 | 139.2 | 139.4 | good |
| 3 | 135.5 | 137.1 | 142.4 | 143.5 | 180.0 | poor |
| 4 | 131.7 | 139.2 | 156.0 | 147.1 | 146.7 | poor |
| 5 | 135.0 | 138.4 | 153.0 | 149.0 | 158.0 | poor |
| 6 | 134.2 | 145.6 | 183.0 | 156.0 | 156.5 | poor |

As shown in Table 1, contact resistances of four battery packs 100, from among the six battery packs 100, were poor. In this case, the sizes of the battery packs 100 used in the RFF test will be described with reference to Table 2 and FIG. 2. Here, W1 and W2, H1 and T1 denote widths, a height and a thickness of the bare cell 110, respectively. W3 and W4, H2 and T2 denote widths, a height and a thickness of the case 150, respectively.

TABLE 2

| | Bare Cell 110 | | | | Case 150 | | | |
|---|---|---|---|---|---|---|---|---|
| | W1 | W2 | H1 | T1 | W3 | W4 | H2 | |
| No. | (mm) | (mm) | (mm) | (mm) | (mm) | (mm) | (mm) | T2 (mm) |
| 1 | 43.81 | 40.40 | 41.86 | 5.16 | 44.11 | 40.38 | 4.68 | 5.75 |
| 2 | 43.79 | 40.40 | 41.85 | 5.17 | 44.10 | 40.39 | 4.69 | 5.76 |
| 3 | 43.79 | 40.39 | 41.84 | 5.16 | 44.09 | 40.39 | 4.67 | 5.76 |
| 4 | 43.79 | 40.40 | 41.85 | 5.17 | 44.10 | 40.40 | 4.69 | 5.76 |
| 5 | 43.80 | 40.40 | 41.83 | 5.16 | 44.10 | 40.39 | 4.71 | 5.76 |
| 6 | 43.81 | 40.40 | 41.85 | 5.17 | 44.10 | 40.38 | 4.68 | 5.75 |
| MIN | 43.79 | 40.39 | 41.83 | 5.16 | 44.09 | 40.38 | 4.67 | 5.75 |
| MAX | 43.81 | 40.40 | 41.86 | 5.17 | 44.11 | 40.40 | 4.71 | 5.76 |
| difference | 0.02 | 0.01 | 0.03 | 0.01 | 0.02 | 0.016 | 0.04 | 0.01 |

Here, the sizes of the bare cell 110 and the case 150 may have values within a predetermined range, so that the bare cell 110 and the case 150 may be uniformly mounted on a jig of an engaging device. In this case, the weight of the battery pack 100 is about 26 g.

A coupled state between the first tap 131 and the cap plate 111a before and after performing the RFF test will be described with reference to FIGS. 3A and 3B. FIG. 3A is an enlarged cross-sectional view of a part 111a of FIG. 1C. FIG. 3B is a cross-sectional view illustrating a state where a RFF test has been performed on the embodiment of FIG. 3A. In FIG. 3A, the first tap 131 and the cap plate 111a are tightly adhered to each other by coupling between the first tapping screw 141 and the cap plate 111a. At this time, a gap g is generated between the first tap 131 and the cap plate 111a after the RFF test is performed, and thus contact resistance therebetween is increased. Surface precision of the first and second tapping screws 141 and 142 may be influenced by the gap g. The surface precision of the first and second tapping screws 141 and 142 may be increased to improve coupling therebetween and to decrease the rate of contact resistance of the battery pack 100.

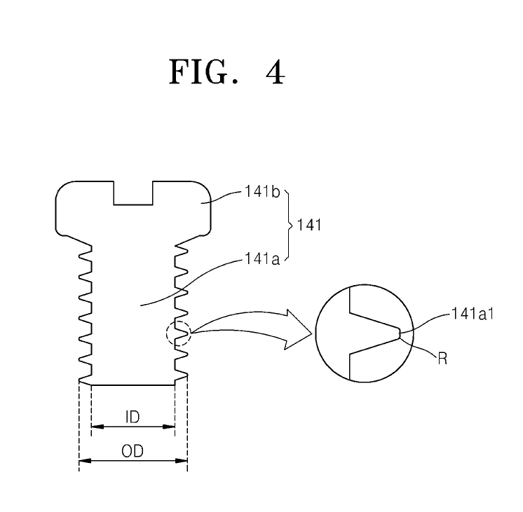

Table 3 shows values of outer diameters (OD) and inner diameters (ID) of an embodiment 4-1 and comparative examples 4-2 and 4-3. Referring to FIG. 4, the outer diameters OD and the inner diameters ID of the first and second tapping screws 141 and 142 are outer diameters and inner diameters of the body parts 141a of the first and second tapping screws 141 and 142, respectively. That is, a circumscribed circle of a peak of the screw thread 141a1 of the body part 141a is the outer diameter OD, and an inscribed circle of a valley of the screw thread 141a1 is the inner diameter ID.

TABLE 3

| | Embodiment | | Comparative | | Comparative | |
|---|---|---|---|---|---|---|
| | 4-1 | | Example 4-2 | | Example 4-3 | |
| | outer | | outer | | outer | |
| | diam- | inner | diam- | inner | diam- | inner |
| | eter | diameter 1 | eter 2 | diameter 2 | eter 3 | diameter 3 |
| No. | 1 (mm) | (mm) | (mm) | (mm) | (mm) | (mm) |
| 1 | 1.212 | 0.875 | 1.217 | 0.869 | 1.211 | 0.869 |
| 2 | 1.216 | 0.867 | 1.215 | 0.858 | 1.213 | 0.873 |
| 3 | 1.209 | 0.872 | 1.212 | 0.877 | 1.219 | 0.873 |
| 4 | 1.205 | 0.872 | 1.216 | 0.862 | 1.210 | 0.868 |
| 5 | 1.210 | 0.870 | 1.217 | 0.874 | 1.200 | 0.874 |
| 6 | 1.205 | 0.871 | 1.215 | 0.876 | 1.206 | 0.880 |
| Max | 1.216 | 0.875 | 1.217 | 0.877 | 1.219 | 0.880 |
| Min | 1.205 | 0.867 | 1.212 | 0.858 | 1.200 | 0.868 |
| Ave | 1.210 | 0.871 | 1.215 | 0.869 | 1.210 | 0.873 |
| Range | 0.011 | 0.008 | 0.005 | 0.019 | 0.019 | 0.012 |

| | | | |
|---|---|---|---|
| Chemical | yes | no | no |
| Polishing | | | |
| Plating | 5.5 | 2.5 | 4.5 |
| Thickness | | | |
| (um) | | | |

Referring to Table 3, in the embodiment 4-1, a chemical polishing process is performed, and a plating thickness is 5.5 um. In the comparative example 4-2, a chemical polishing process is not performed, and a plating thickness is 2.5 um. In the comparative example 4-3, a chemical polishing process is not performed, and a plating thickness is 4.5 um. When the embodiment 4-1 is applied to the battery pack 100, an error rate of the battery pack 100 is 2,000 ppm (parts-per-million). On the other hand, when the comparative examples 4-2 and 4-3 are applied to the battery pack 100, the error rate of the battery pack 100 is 20,000 ppm. As such, the difference of the error rate shows that surface states of the first and second tapping screws 141 and 142 are changed according to whether or not the chemical polishing process has been performed, and thus the surface states of the first and second tapping screws 141 and 142 affect the error rate of the battery pack 100. In general, when small-sized first and second tapping screws 141 and 142 are manufactured, a chemical polishing process is not performed. However, a chemical polishing process may be added when the small-sized first and second tapping screws 141 and 142 are manufactured, so as to control surface roughnesses of the first and second tapping screws 141 and 142. In this case, the small-sized first and second tapping screws 141 and 142 may be tapping screws each having a height of less than 6 mm.

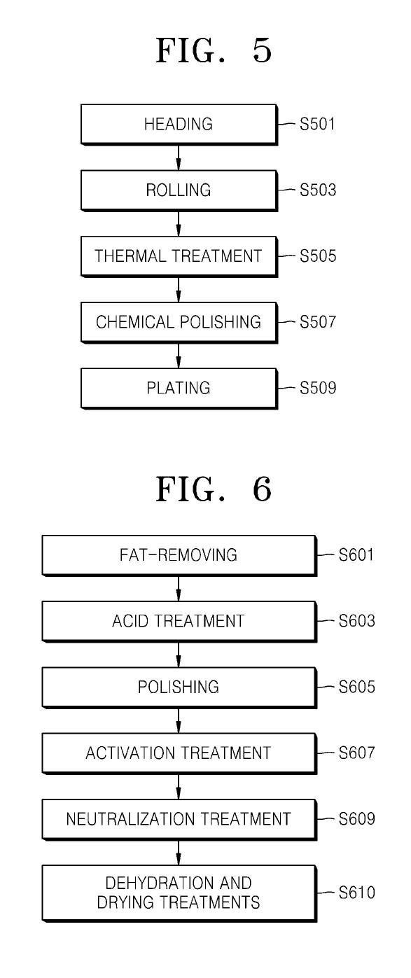

A method of manufacturing the small-sized first and second tapping screws 141 and 142 will now be described with reference to FIG. 5.

First, a raw material for forming the first and second tapping screws 141 and 142 is prepared. The raw material may be carbon steel such as SWCH18A. The head part 141b may be formed by processing the raw material (S501). A screw thread may be formed by performing a rolling process (S503). A thermal treatment may be performed on the first and second tapping screws 141 and 142 through quenching (HV800) and tempering (HV 500˜520) processes (S505). Then, sizes of the first and second tapping screws 141 and 142 may be processed through a chemical polishing process (S507). Then, a plating process may be performed thereon in order to prevent metal oxidization (S509).

Table 4 shows values of outer diameters OD and inner diameters ID of the tapping screw through the rolling (S503), chemical polishing process (S507) and plating process (S509).

TABLE 4

| | Outer Diameter | | | Inner Diameter | | |
|---|---|---|---|---|---|---|
| | OD of Screw | | | ID of Screw | | |
| | | chemical | | | chemical | |
| | rolling | polishing | plating | rolling | polishing | plating |
| No. | (mm) | (mm) | (mm) | (mm) | (mm) | (mm) |
| 1 | 1.269 | 1.250 | 1.255 | 0.908 | 0.900 | 0.913 |
| 2 | 1.257 | 1.239 | 1.250 | 0.903 | 0.896 | 0.916 |
| 3 | 1.255 | 1.237 | 1.250 | 0.901 | 0.895 | 0.918 |

Referring to Table 4, a variation of the outer diameters OD of the first and second tapping screws 141 and 142 is greatest during the chemical polishing process. This is because an area of a peak of the screw thread 141a1 is small compared to the inner diameters ID of the first and second tapping screws 141 and 142, and thus the variation of the outer diameter OD decreasing due to the chemical polishing process (S507) is great. The variation of the inner diameters ID of the first and second tapping screws 141 and 142 is greatest during the plating process. Since a surface of the body part 141a is advantageous to deposition of plating during the plating process (S509), the variation of the inner diameter ID may be great during the plating process (S509). Referring to FIG. 4, a corner of the screw thread 141a1 is rounded R in the chemical polishing process, and the surface roughnesses of the first and second tapping screws 141 and 142 become uniform, and thus interference between the surfaces of the tapping screws and a bare cell 110 is reduced, and the first tapping screw 141 may be inserted with a small torque. Also, the chemical polishing process reduces distribution of the first tapping screw 141, thereby reducing an error rate of the battery pack 100.

The chemical polishing process (S507) will now be described in detail with reference to FIG. 6. After the thermal treatment (S505) is performed, a fat-removing process is performed by controlling a composition ratio of caustic soda, surfactant and water to be 1:4:10 (S601). Then, an acid treatment may be performed on the tapping screws 141 and 142 by controlling a composition ratio of hydrochloric acid, scale remover and water to be 10:1:10 (S603). Then, a polishing solution is prepared, wherein a composition ratio of ammonium hydrogen-fluoride, hydrogen peroxide and water in the polishing solution is 1:2:10, and then a polishing process is performed on the tapping screws 141 and 142 (S605). Then, hydrochloric acid and water are activated with a composition ratio of 1:2 (S607), and a neutralization treatment may be performed on the tapping screws 141 and 142 through surfactant and sodium tripolyphosphate (S609). Then, dehydration and drying treatments are performed on the tapping screws 141 and 142 (S601), thereby completing the chemical polishing process (S507).

The chemical polishing process of FIG. 6 is just an embodiment, and each material may have various composition ratios. The surface states of the first and second tapping screws 141 and 142 may be changed according to a composition ratio of the ammonium hydrogen-fluoride, hydrogen peroxide and water in the polishing solution of the polishing process (S605), a working environment or a working condition. Also, if the surface roughnesses of the first and second tapping screws 141 and 142 are not uniform, even though the plating process (S509) is performed on the first and second tapping screws 141 and 142 afterwards, the surfaces become non-uniform. Accordingly, the chemical polishing process (S507) should be performed in consideration of major factors affecting the chemical polishing process (S507).

According to the chemical polishing process (S507) of this embodiment of the present invention, the major factors affecting the chemical polishing process (S507) may be controlled so as to process the sizes of the first and second tapping screws 141 and 142 and to control the surface roughnesses thereof. That is, as shown in Table 4, the outer diameters and the inner diameters of the first and second tapping screws 141 and 142 are changed through the chemical polishing process (S507), and the sizes of the first and second tapping screws 141 and 142 may be processed in consideration of factors affecting the variation of the outer diameters and the inner diameters of the first and second tapping screws 141 and 142. In this case, the factors affecting the chemical polishing process (S507) may be concentration and temperature of the polishing solution used in the chemical polishing process and time for the reaction between the polishing solution and the tapping screws 141 and 142 (S507).

Table 5 shows a variation of the outer and inner diameters and the surface roughnesses of the first and second tapping screws 141 and 142 according to the concentration of the polishing solution in the chemical polishing process (S507).

TABLE 5

| | | | | Result of Chemical Polishing | | |
|---|---|---|---|---|---|---|
| | Processing Condition | | | polishing | | |
| | concen- | temper- | | solution | inner | |
| | tration | ature | time | (OD) | diameter | |
| No. | (hydrometer) | (° C.) | (s) | (mm) | ID (mm) | Note |
| 1 | 1 | 40 | 10 | 1242 | 0.898 | low gloss |
| 2 | 3 | | | 1.241 | 0.899 | low gloss |
| 3 | 5 | | | 1.234 | 0.895 | good |
| 4 | 7 | | | 1.227 | 0.893 | good |
| 5 | 9 | | | 1.233 | 0.894 | good |
| 6 | 11 | | | 1.186 | 0.874 | dimen- |
| | | | | | | sional |
| | | | | | | error |

When the concentration of the polishing solution is 5 through 9, the sizes and surface roughnesses of the first and second tapping screws 141 and 142 are good. The concentration may be measured through a Baum's hydrometer. A weight of a material at a predetermined temperature is a unique value of the material. Accordingly, purity of the polishing solution may be checked by measuring the weight. That is, the weight may be measured by using a relation between the weight and concentration of the polishing solution.

Referring table 6, the concentration of the polishing solution may vary according to a composition ratio of ammonium hydrogen-fluoride, hydrogen peroxide and water.

TABLE 6

| | | | | | | |
|---|---|---|---|---|---|---|
| Ammonium hydrogen- | 100 | 100 | 100 | 100 | 100 | 100 |
| fluoride (ml) | | | | | | |
| hydrogen peroxide (ml) | 50 | 100 | 200 | 250 | 300 | 350 |
| Water (ml) | 1000 | 1000 | 1000 | 1000 | 1000 | 1000 |
| Concentration of a Baum's | 1 | 3 | 5 | 7 | 9 | 11 |
| hydrometer | | | | | | |

Table 7 shows a variation and surface roughnesses of the outer and inner diameters of the first and second tapping screws 141 and 142 according to a temperature of the polishing solution.

TABLE 7

| | | | | Result of Chemical | | |
|---|---|---|---|---|---|---|
| | Processing Condition | | | Polishing | | |
| | concen- | temper- | | outer | inner | |
| | tration | ature | time | diameter | diameter | |
| No. | (hydrometer) | (° C.) | (s) | OD (mm) | ID (mm) | Note |
| 1 | 9 | 10 | 10 | 1.246 | 0.897 | rough |
| 2 | | 20 | | 1.239 | 0.896 | low gloss |
| 3 | | 30 | | 1.235 | 0.894 | good |
| 4 | | 40 | | 1.233 | 0.894 | good |
| 5 | | 50 | | 1.228 | 0.889 | good |
| 6 | | 70 | | 1.222 | 0.889 | lowest |
| | | | | | | limit |
| | | | | | | of size |

When a temperature of the polishing solution is 30° C. through 50° C., the first and second tapping screws 141 and 142 had preferable sizes and surface roughnesses. That is, the sizes and surface roughnesses of the first and second tapping screws 141 and 142 may be controlled by controlling the temperature of the polishing solution during the chemical polishing process (S507).

Table 8 shows a variation of outer and inner diameters and surface roughnesses of the first and second tapping screws 141 and 142 according to time.

TABLE 8

| | Processing Condition | | | Result of Chemical Polishing | | |
|---|---|---|---|---|---|---|
| | concen- | temper- | | outer | inner | |
| | tration | ature | time | diameter | diameter | |
| No. | (hydrometer) | (° C.) | (s) | OD (mm) | ID (mm) | Note |
| 1 | 9 | 40 | 5 | 1.244 | 0.896 | inner |
| | | | | | | diameter |
| | | | | | | is rough |
| 2 | | | 10 | 1.233 | 0.894 | good |
| 3 | | | 15 | 1.226 | 0.890 | good |
| 4 | | | 20 | 1.209 | 0.886 | lowest |
| | | | | | | limit of |
| | | | | | | size |
| 5 | | | 30 | 1.183 | 0.876 | poor size |
| 6 | | | 40 | 1.159 | 0.868 | poor size |

Referring to Table 8, when time is 10 s through 15 s, the first and second tapping screws 141 and 142 had preferable sizes and surface roughnesses.

Accordingly, referring to Tables 5 through 8, when the concentration is through 9, when the temperature of the polishing solution is 30° C. through 50° C., and when the time for the reaction between the polishing solution and the tapping screws 141 and 142 is 10 s through 15 s, the first and second tapping screws 141 and 142 had preferable sizes and surface roughnesses. Also, values of the sizes and surface roughnesses of the first and second tapping screws 141 and 142 may be obtained by satisfying the concentration and temperature of the polishing solution and time for the reaction between the polishing solution and the tapping screws 141 and 142.

Now, a condition in which the concentration is 5 through 9, the temperature is 30° C. through 50° C., and the time for the reaction between the polishing solution and the tapping screws 141 and 142 is 10 s through 15 s, is defined as a first condition. For example, the outer diameters OD of the first and second tapping screws 141 and 142 having undergone the chemical polishing process (S507) according to the first condition may be 1.22 mm through 1.27 mm, and the inner diameter ID thereof may be 0.88 mm through 0.93 mm. In more detail, the outer diameter OD may be 1.226 mm through 1.235 mm, and the inner diameter ID may be 0.889 mm through 0.895 mm. However, the present invention is not limited thereto. Thus, since the concentration and temperature of the polishing solution and time for the reaction between the polishing solution and the tapping screws 141 and 142 may affect the sizes and surface roughnesses of the first and second tapping screws 141 and 142, the first and second tapping screws 141 and 142 may be manufactured by controlling the concentration and temperature of the polishing solution and time for the reaction between the polishing solution and the tapping screws 141 and 142.

Coupling and a coupling error rate of the first and second tapping screws 141 and 142 coupled with a light alloy metal are significantly different according to surface precision of the first and second tapping screws 141 and 142. That is, minute burs, external substances, etc. generated during the manufacturing process of the first and second tapping screws 141 and 142 undergo the chemical polishing process (S507), and thus the shape of the screw threads 141a1 of the first and second tapping screws 141 and 142 are rounded and the surfaces of the screw threads 141a1 are smoothened. Accordingly, frictional resistance generated when the first and second tapping screws 141 and 142 are coupled with the light alloy metal and damage to the light alloy metal are minimized, thereby improving coupling of the first and second tapping screws 141 and 142. For example, the first and second tapping screws 141 and 142 having undergone the chemical polishing process (S507) according to the first condition may have clamping force of about 180 N when being coupled with the first and second screw receiving openings 112 and 113.

Table 9 shows a result of the RFF test performed on the battery pack 100 using the first and second tapping screws 141 and 142 whose sizes are processed through the chemical polishing process (S507), under the first condition.

TABLE 9

| | Initial | 50 times | 100 times | 150 times | 200 times | |
|---|---|---|---|---|---|---|
| No. | (mΩ) | (mΩ) | (mΩ) | (mΩ) | (mΩ) | Note |
| 1 | 132.3 | 132.4 | 131.5 | 136.5 | 134.1 | good |
| 2 | 130.1 | 131.7 | 138.5 | 139.7 | 139.3 | good |
| 3 | 130.3 | 133.1 | 132.3 | 133.2 | 135.1 | good |
| 4 | 130.2 | 132.2 | 136.6 | 137.1 | 136.2 | good |
| 5 | 131.2 | 134.4 | 133.2 | 135.1 | 138.2 | good |
| 6 | 131.5 | 132.6 | 133.3 | 136.8 | 136.5 | good |

Compared to the result of Table 1, the results of Table 9 are significantly improved.

Also, the battery pack 100 has a coupling error rate of less than about 1,000 ppm during a coupling process, and thus process stability has been improved.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A battery pack comprising:
a bare cell having an electrode assembly and a cap plate;
a protection circuit module positioned on top of the cap plate;
a cover that is positioned over the protection circuit module; and
at least one threaded connector that engages with the cover and the protection circuit module and is secured into the cap plate so as to secure the cover and the protection circuit module to the cap plate, wherein the threads of the at least one connector are polished and the polished threads engage with the cap plate to secure the at least one threaded connector to the cap plate.

2. The battery pack of claim 1, wherein the threads of at least one connector is polished by chemical polishing.

3. The battery pack of claim 1, further comprising at least one tap that supports the protection circuit module to the bare cell, wherein the at least one tap includes an opening that receives the threaded shaft of the at least one threaded connector.

4. The battery pack of claim 3, wherein the at least one threaded connector comprises a first and second threaded connector and the at least one tap comprises a first and second tap that receives the first and second threaded connectors.

5. The battery pack of claim 1, wherein the at least one threaded connector comprises a first and a second threaded connectors.

6. The battery pack of claim 5, wherein the first and second threaded connectors comprise screws having heads and threaded shafts and wherein the threaded shafts engage with the inner surfaces of openings positioned on the cap plate to secure the first and second threaded connectors to the cap plate.

7. The battery pack of claim 1, wherein the cap plate includes an opening that receives the at least one threaded connector and wherein the end of the threaded connector is spaced from the bottom of the opening so as to define a gap between the end of the threaded connector and the cap plate.

8. The battery pack of claim 1, wherein the threads of the at least one threaded connector are plated.

9. The battery pack of claim 8, wherein the threads of the at least one threaded connector are plated to prevent metal oxidization.

10. The battery pack of claim 1, wherein the cover includes an opening that receives the at least one threaded connector.

11. The battery pack of claim 10, further comprising a cap that is positioned within the opening of the cover so that the cap is interposed between the exterior of the opening and the at least one threaded connector.

12. A method of making a battery pack comprising:
providing at least one threaded connector that is dimensioned to be used to secure a cover and a protection circuit module to a bare cell of a battery pack; and
polishing at least one threaded connector to polish the threads of the at least one threaded connector so as to control the size of the threads of the at least one threaded connector.

13. The method of claim 12, wherein polishing the at least one threaded connector comprises chemically polishing the at least one threaded connector.

14. The method of claim 13, wherein chemically polishing the at least one threaded connector comprises:
performing a fat removing process using caustic soda, surfactant and water;
performing an acid treatment by controlling the composition ratio of hydrochloric acid, scale remover and water;
polishing the at least one threaded connector using an ammonium hydrogen-fluoride, hydrogen peroxide and water polishing solution;
activating the acid treatment;
neutralizing the at least one threaded connector using a surfactant and sodium tripolyphosphate.

15. The method of claim 12, further comprising plating the at least one threaded connector.

16. The method of claim 12, wherein polishing at least one threaded connector comprises using a polishing solution and controlling the temperature of the polishing solution to control the sizes and surfaces roughnesses of the at least one threaded connector.

17. The method of claim 16, wherein polishing at least one threaded connector comprises using a polishing solution and controlling the reaction time that the at least one threaded connector is in the polishing solution.

18. The method of claim 17, wherein the temperature is controlled to approximately 30 to 50 degrees Celsius and the reaction time is controlled to approximately 10 seconds to 15 seconds.

19. The method of claim 18, wherein the outer diameter of the at least one fastener treated according to the method of claim 17 may be approximately 1.22 mm to approximately 1.27 mm and the inner diameter may be approximately 0.88 mm to approximately 0.93 mm.

20. The method of claim 19, wherein the outer diameter of the at least one fastener is approximately 1.226 mm to approximately 1.235 mm and the inner diameter may be approximately 0.889 mm to approximately 0.895 mm.
